(19) United States
(12) Patent Application Publication
(10) Pub. No.: US 2019/0041425 A1
(43) Pub. Date: Feb. 7, 2019

(54) METHOD FOR DETECTING A DEFECT IN AN ACCELERATION SENSOR, AND MEASURING SYSTEM

(71) Applicant: SIEMENS AKTIENGESELLSCHAFT, Muenchen (DE)

(72) Inventors: CHRISTIAN KITZMUELLER, GRAZ (AT); MARKUS KNOLL, NUERNBERG (DE); HUGO RACKL, STATTEGG (AT); KASPAR SCHROEDER-BODENSTEIN, DUESSELDORF (DE)

(73) Assignee: SIEMENS AKTIENGESELLSCHAFT, Muenchen (DE)

(21) Appl. No.: 15/764,887

(22) PCT Filed: Sep. 6, 2016
(86) PCT No.: PCT/EP2016/070946

§ 371 Date: Mar. 30, 2018

(30) Foreign Application Priority Data
Sep. 30, 2015 (DE) 10 2015 218 941.4

(51) Int. Cl. G01P 21/00; B61L 3/00

(52) U.S. Cl. CPC G01P 21/00; B61L 3/008

(57) ABSTRACT

A method detects a defect in an acceleration sensor. In order to be able to reliably detect a defect in an acceleration sensor, the acceleration sensor generates a signal which is checked during a test as to whether a variable dependent on the signal fulfills a predefined condition with respect to a reference value and, on the basis of the test, it is determined whether the acceleration sensor is defective.

The invention relates to a method for detecting a defect in an acceleration sensor.

Acceleration sensors are used in many technical fields. For example, an acceleration sensor can be installed in a vehicle in order to increase the vehicle's safety.

In a rail vehicle, for example, lateral acceleration of the rail vehicle or more specifically of an individual car can be measured using an acceleration sensor, in particular in order to monitor the so-called hunting oscillation of the rail vehicle. The hunting oscillation of a rail vehicle, also known as sway, can be understood as meaning an oscillation of the rail vehicle about its ideal trajectory. This oscillation can be caused by outwardly tapering, (approximately) conical wheels rigidly coupled via an axle and occurs in particular at high speeds of the rail vehicle. If the wheels are positioned eccentrically on two parallel rails, the outwardly offset wheel rolls with a larger effective diameter, so that the axle deflects inward. The rail vehicle or car experiences a lateral acceleration. High lateral accelerations may result in wheel wear and/or track damage. With high lateral accelerations there is even a risk of derailment.

By means of an acceleration sensor, the lateral acceleration of a vehicle can be measured and a warning of high acceleration values can be issued in order, for example, to ensure the safety of the occupants of the vehicle and/or to guard against track damage in the case of a rail vehicle.

However, an acceleration sensor may be defective, e.g. because of wire breakage inside the sensor, and consequently provide erroneous signals. Erroneous signals may result in a false warning, for example, i.e. a warning is issued even though the situation is non-critical. In addition, erroneous signals may result in critical situations not being detected and therefore erroneously cause no warning to be issued. It is therefore important to detect a defect in the acceleration sensor.

An object of the present invention is to specify a method whereby a defect in an acceleration sensor can be reliably detected.

This object is achieved by a method for detecting a defect in an acceleration sensor, wherein the acceleration sensor inventively produces a signal, a test is performed to check whether a signal-dependent variable fulfills a predefined condition in respect of a reference value, and, on the basis of the test, it is determined whether the acceleration sensor is defective.

The test is used to check whether the variable dependent on the acceleration sensor signal is plausible. The method according to the invention enables an acceleration sensor defect to be detected reliably and, in particular, at an early stage. In the event of an acceleration sensor being defective, it is then deactivated, repaired and/or replaced. This advantageously ensures the availability of a plausible acceleration sensor signal.

The test to ascertain whether the signal-dependent variable fulfills the predefined condition can be performed by a monitoring unit. For example, software for carrying out the test can be stored in the monitoring unit. The monitoring unit preferably receives the signal produced by the acceleration sensor and/or the signal-dependent variable indirectly or directly from the acceleration sensor.

The variable can be, among other things, a signal value, i.e. a value of the signal produced by the acceleration sensor. The signal is preferably a voltage signal. In other words, the variable can be a voltage or more specifically a voltage value.

The signal-dependent variable is preferably an acceleration variable determined on the basis of the signal (or rather an acceleration value determined on the basis of the signal).

Monitoring the acceleration determined on the basis of the signal provides a reliable test, unlike in the case of a method in which e.g. a voltage offset of the acceleration sensor is monitored. Because if an acceleration sensor defect is present, the acceleration sensor may supply a correct offset voltage but an erroneous acceleration value (e.g. always zero).

Alternatively, the variable can be another variable derived i.e. determined from the signal of the acceleration sensor. The reference value is logically a value of the same physical variable.

It is advantageous if the signal-dependent variable is a variable calculated by averaging a plurality of consecutive signal values. This means that preferably a plurality of consecutive signal values are averaged, in particular before the test is carried out. Averaging enables the signal to be smoothed. Preferably, a time period for which the averaging is carried out can be predefined.

The averaging can be e.g. quadratic averaging. The averaging can also be arithmetic absolute value averaging. For arithmetic absolute value averaging, first the absolute value of each signal value is advantageously taken and then arithmetic averaging of a plurality of signal values is performed. In addition, the averaging can be so-called moving averaging, i.e. a moving average value can be calculated for each signal value. The reference value can be dependent on the type of averaging.

In a preferred embodiment of the invention, the acceleration sensor signal is filtered using a filter. In addition, the test is advantageously carried out on the filtered signal. In other words, the filtering of the signal preferably takes place prior to the test. The signal is preferably filtered prior to averaging of the signal values.

The acceleration sensor is usefully disposed in a movable object. Filtering of the signal enables the frequencies and/or frequency bands in which no mechanical vibrations of the object are likely to occur to be attenuated. In addition, the filtering enables interference frequencies and/or an offset voltage in the signal to be attenuated or rather filtered out of the signal. Filtering of the signal also enables signal noise to be reduced. This makes it easier to evaluate the signal and/or calculate an acceleration.

The filter is preferably a bandpass filter. The bandpass filter advantageously allows through the frequency range in which mechanical vibrations of said object are likely to occur. A bandpass filter enables the frequencies and/or frequency bands in which no mechanical vibrations of the object are likely to occur to be attenuated or rather filtered out of the signal.

The filter can also be a high-pass filter. The high-pass filter advantageously attenuates the offset voltage in the signal or rather filters it out of the signal. In addition, the high-pass filter preferably allows through the frequency range in which mechanical vibrations of the object are likely to occur.

The filter can also be a low-pass filter. The low-pass filter preferably allows through the frequency range in which mechanical vibrations of the object are likely to occur. The low-pass filter advantageously attenuates or filters out frequencies higher than the likely frequencies of the mechanical vibrations. In addition, the acceleration sensor signal can be filtered using a combination of a plurality of different filters.

In an advantageous embodiment of the invention, the reference value is a maximum value of a measurement range of the acceleration sensor. The maximum value can be considered as the peak value of the measurement range of the acceleration sensor. The test preferably checks whether the variable, in particular an averaged signal value and/or an averaged acceleration value, exceeds a predefined multiple of the reference value. The multiple can be a rational number. The multiple can also be one, i.e. it can be checked whether the variable exceeds the reference value.

If the variable exceeds the predefined multiple of the reference value, an acceleration sensor defect is generally present. It is advantageously interpreted as a fault in the acceleration sensor, i.e. an acceleration sensor defect, if the variable exceeds the predefined multiple of the reference value. In addition, the test enables the operability a filter, in particular a filter connected downstream of the acceleration sensor, to be checked. For example, a filter defect may be present if the variable exceeds the predefined multiple of the reference value. On the basis of the detected defect, the filter and/or the acceleration sensor can be examined and the defective item repaired or replaced if necessary. In addition, during the test an auxiliary variable which is determined independently of the acceleration sensor signal can be checked to establish whether the signal-dependent variable is plausible. The auxiliary variable can be, for example, a state variable which characterizes a state of the object in which the acceleration sensor is disposed. For example, the auxiliary variable can be a speed of the object. The auxiliary variable can also be determined e.g. using a measuring device, in particular using a speedometer. In particular, the test can check whether an acceleration determined from the signal is plausible for a speed determined independently of the acceleration sensor.

In a preferred embodiment of the invention, the acceleration sensor, as mentioned above, is disposed in or on a movable object. In an advantageous variable of the invention, the condition is dependent on a speed of the object. In this case the reference value is preferably dependent on a speed of the object. This makes it possible to test whether the signal-dependent variable is plausible for the current speed of the object. It is assumed here that, at a particular speed of the object, particular values are likely for the variable dependent on the acceleration sensor signal.

The speed of the object is preferably measured by means of a speedometer. It is also preferable if the speedometer operates independently of the acceleration sensor, so that an acceleration sensor defect is not necessarily accompanied by a speedometer defect or malfunction.

The object can be, among other things, a transportation device such as e.g. an elevator, or some other movable object. Preferably the object is a vehicle, e.g. a rail vehicle. Alternatively, the vehicle can be a cable car, for example, in particular of a cable railway or fairground ride, or some other vehicle.

The speedometer can comprise, for example, a rotational speed sensor. This means that the speed of the object can be determined e.g. on the basis of a rotational speed determined by the rotational speed sensor. The rotational speed sensor can be placed e.g. on a rotatable axle of the object, in particular on an axle connected to a wheel of the object. Standstill of the object can be determined, among other things, by a brake control unit. Using the brake control unit, it is preferably possible to ascertain whether the speed of the object is below a predefined lower speed limit (of e.g. 0.5 km/h).

The speedometer and/or the brake control unit is/are preferably designed to communicate the speed of the object to the above mentioned monitoring unit.

A time counter is advantageously used to count, in particular to increment or decrement, a time. The time is counted by the time counter in particular from a starting or initial value to a predefined or predefinable time value. When the time reaches the predefined or predefinable time value, the time counter can be reset, in particular to its starting or initial value.

If the speed of the object falls below a predefined lower speed limit, the test preferably checks whether the variable exceeds the reference value by the time the predefined time value is reached. If the variable exceeds the reference value by the time the predefined time value is reached, an acceleration sensor defect may be present. It is preferably interpreted as a defect in the acceleration sensor, i.e. an acceleration sensor defect is detected, if the variable exceeds the reference value by the time the predefined limit value is reached.

If the speed of the object falls below a predefined lower speed limit, the test preferably determines how often the variable exceeds the reference value by the time the predefined limit value is reached. In this case the test preferably also checks whether the number of exceedances exceeds a predefined maximum number. If the number of exceedances exceeds the predefined maximum number by the time the predefined time value is reached, an acceleration sensor defect may be present. It is preferably interpreted as a defect in the acceleration sensor, i.e. an acceleration sensor defect is detected, if the number of exceedances exceeds the predefined maximum number by the time the predefined time value is reached.

The number of exceedances is preferably determined by an exceedance counter. The exceedance counter is advantageously reset if the number of exceedances is less than the predefined maximum number by the time the predefined time value is reached. When it is reset, the exceedance counter is preferably set to its starting value or initial value, in particular to zero. The monitoring counter can be a separate device or implemented as a software function, e.g. in the monitoring unit.

Advantageously, the time is only counted by this time counter if the speed of the object falls below the predefined lower speed limit. The time counter can be stopped if the speed of the object is equal to the predefined lower speed limit or above the predefined lower speed limit. In addition, the time counter can resume counting the time if the speed of the object again falls below the predefined lower speed limit, in particular from the time value that had been reached when it was stopped.

Alternatively, the time counter can be reset to its starting or initial value if the speed of the object is equal to the predefined lower speed limit or above the predefined lower speed limit.

It is advantageous, in particular during maintenance and/or repair of the object, if testing can be stopped and/or the exceedance counter deactivated. This enables warnings to be prevented from being issued e.g. as the result of jolting during the maintenance and/or repairs, causing the variable to exceed the reference value by the time the predefined limit value is reached.

Advantageously, an additional time is preferably counted, in particular incremented or decremented, by another time counter. The time is advantageously counted by the other time counter in particular from a starting or initial value to another predefined or predefinable time value. The additional time value can be different from the first mentioned time value.

If the speed of the object exceeds a predefined upper speed limit, it is advantageously checked whether the variable ever exceeds the predefined reference value by the time the predefined limit value is reached. If the variable never exceeds the predefined third reference value by the time the predefined limit value is reached, an acceleration sensor defect may be present. It is advantageously interpreted as a defect in the acceleration sensor, i.e. an acceleration sensor defect is detected, if the variable never exceeds the predefined reference value by the time the predefined limit value is reached.

The last mentioned time counter is preferably reset, in particular to its starting or initial value, each time the reference value is exceeded. The time is advantageously only counted by this time counter if the speed of the object exceeds the predefined upper speed limit. In addition, the other time counter can be stopped if the speed of the object is less than or equal to the upper speed limit. If the speed of the object again exceeds the predefined upper speed limit, the time continues being counted by the other time counter, in particular from the time value at which the break was reached.

The first mentioned time counter and the last mentioned time counter can each be implemented as a separate device or as a software function, e.g. in the monitoring unit.

It is preferred if the acceleration sensor is a sensor for measuring an acceleration at right angles to a direction of travel of the object. In other words, the acceleration can be a lateral acceleration. When it is working properly, the acceleration sensor advantageously measures the actual lateral acceleration of the object. In the event of an acceleration sensor defect, the signal produced by the acceleration sensor may be unrelated to the actual lateral acceleration of the object.

A warning is advantageously issued if an acceleration sensor defect is detected. The warning can be an audible and/or a visual warning, for example. If such a warning is present, the acceleration sensor can be tested and repaired or replaced if necessary.

It is also advisable in the event of a detected acceleration sensor defect for said acceleration sensor to be no longer used to determine an acceleration. In particular, the signal of this acceleration sensor can be set as invalid. This acceleration sensor can also be switched off.

In a preferred embodiment of the invention, the acceleration sensor is disposed in a rail vehicle. The acceleration sensor is preferably used to monitor running stability. In the context of running stability monitoring, the lateral acceleration and/or lateral oscillation of the rail vehicle is/are monitored. Running stability monitoring enables action to be taken to prevent track damage and/or derailment of the rail vehicle.

A plurality of tests are preferably carried out to check whether a signal-dependent variable fulfills a predefined condition in respect of a reference value. The various tests are preferably used to check different conditions. In addition, the various tests can be performed for the same or different signal-dependent variables. Particularly if the same signal-dependent variable is checked in different tests, this variable is preferably checked in respect of different reference values.

In a first test it can be checked whether a signal-dependent variable fulfills a first predefined condition in respect of a first reference value. For example, the first reference value can be a maximum value of a measurement range of the acceleration sensor.

In addition, in a second test it can be checked whether a signal-dependent variable fulfills a second predefined condition in respect of a second reference value. The second test is preferably carried out if the speed of the object in which the acceleration sensor is advantageously disposed falls below the predefined lower speed limit.

In addition, in a third test it can be checked whether a signal-dependent variable fulfills a third predefined condition in respect of a third reference value. The third test is preferably carried out if the speed of the object in which the acceleration sensor is advantageously disposed exceeds the predefined upper speed limit. The respective reference value, in particular the second and/or the third reference value, can be a function of the speed of the object.

The invention also relates to a measuring system. The measuring system comprises an acceleration sensor and a monitoring unit. The monitoring unit is inventively designed to detect a defect in the acceleration sensor according to the inventive method and/or according to at least one of the above described further developments of the method.

This measuring system can be used in particular in the above described method. In addition, specific elements mentioned in connection with the method, such as e.g. the speedometer and the software, can be component parts of said measuring system.

The acceleration sensor is advantageously designed to produce a signal. In addition, the monitoring unit is advantageously designed to check whether a variable dependent on the acceleration sensor signal fulfills a predefined condition in respect of a reference value. The monitoring unit is also advantageously designed to determine, on the basis of the test, whether the acceleration sensor is defective.

The measuring system or parts thereof can be disposed in a movable object, in particular in a vehicle. In addition, the measuring system can incorporate a plurality of acceleration sensors.

The invention is also applicable to a rail vehicle incorporating the measuring system according to the invention.

The above description of advantageous embodiments of the invention contains numerous features, some of which are cited in combined form in the individual sub-claims. However, these features can also be advantageously considered individually and aggregated to form other meaningful combinations. In particular, these features can each be combined singly and in any suitable combination with the inventive method and the inventive measuring system. Thus, method features may also be regarded as being concretely formulated as characteristic of the corresponding device unit, and vice versa.

Even if some terms are used in the singular or in conjunction with a numeral in the description or in the claims, the scope of the invention shall not be limited to the singular or the respective numeral for these terms. Moreover, the words “a” or “an” are not to be understood as numerals but as indefinite articles.

The above described characteristics, features and advantages of the invention and the way in which they are achieved will become clearer and more readily comprehensible in conjunction with the following description of the exemplary embodiments which will be explained in greater detail with reference to the accompanying drawings. The exemplary embodiments serve to explain the invention and do not limit the invention to the combinations of features specified therein, nor in relation to the functional features. In addition, suitable features of each exemplary embodiment can also be explicitly considered in isolation, removed from the exemplary embodiment, incorporated in another exemplary embodiment for the supplementation thereof and combined with any of the claims.

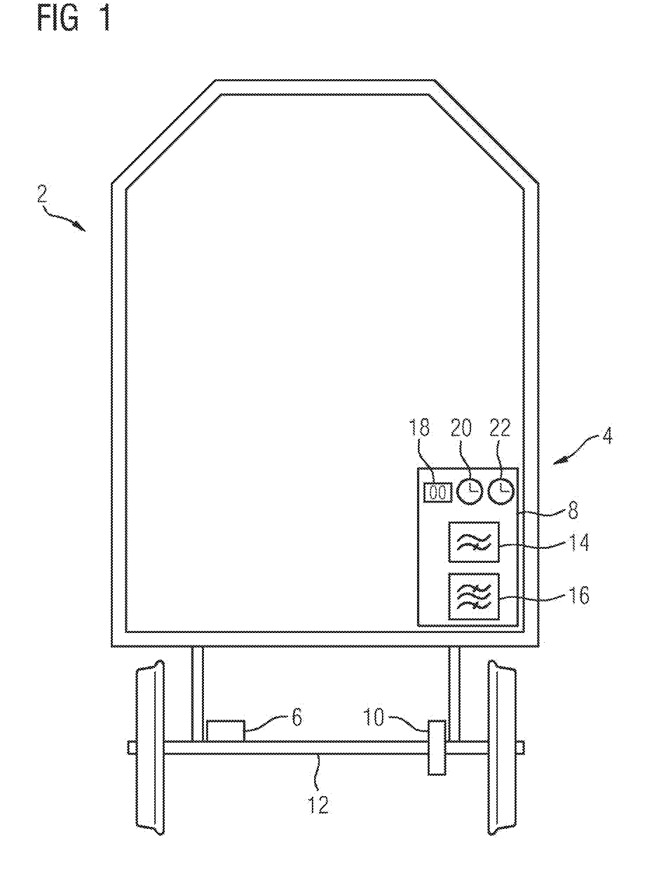

FIG. 1 shows a rail vehicle having a measuring system comprising an acceleration sensor and a monitoring unit;

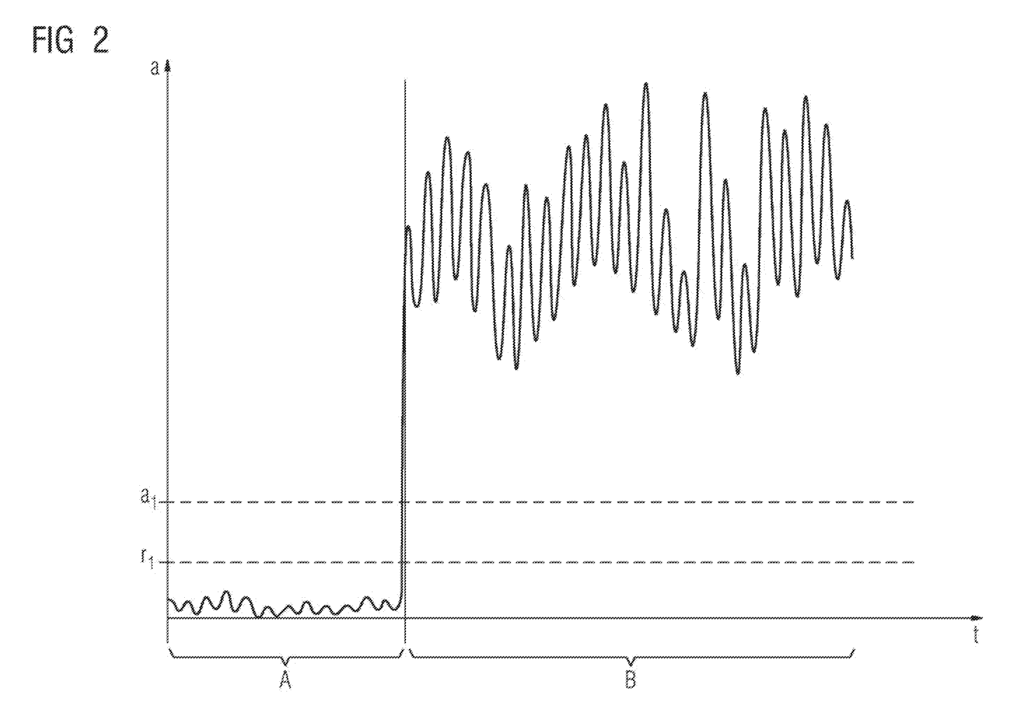

FIG. 2 shows a first graph in which an acceleration of the rail vehicle is plotted as a function of time;

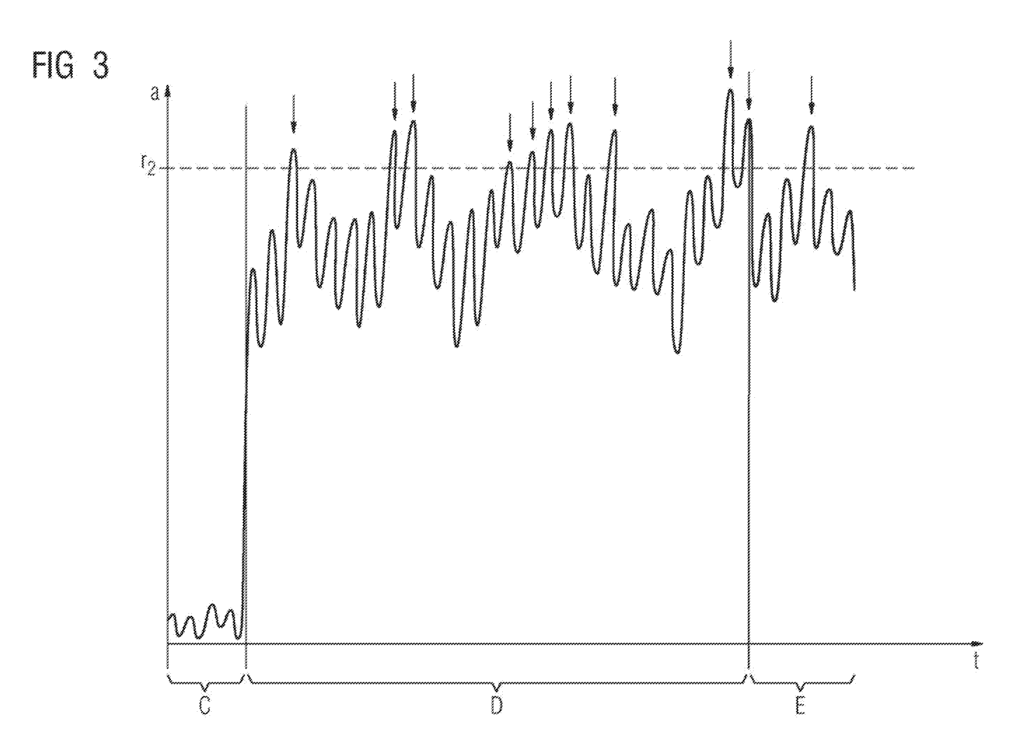

FIG. 3 shows a second graph in which an acceleration of the rail vehicle is plotted as a function of time; and

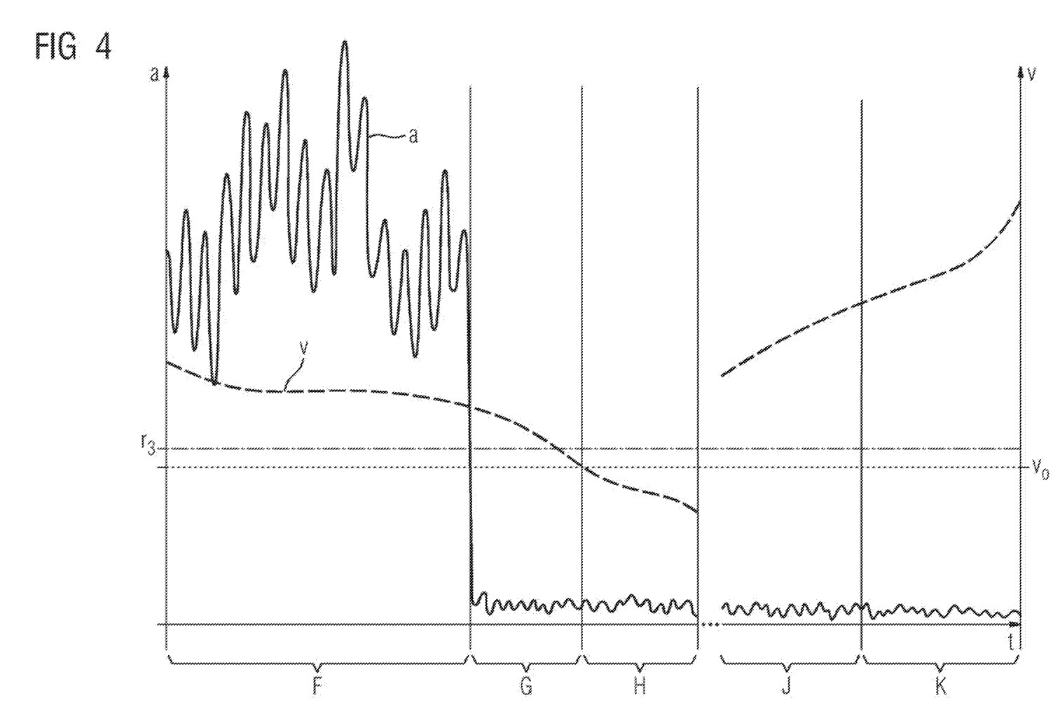

FIG. 4 shows a third graph in which an acceleration and a speed of the rail vehicle are plotted as a function of time.

FIG. 1 schematically illustrates a rail vehicle 2 having a measuring system 4. The measuring system 4 comprises an acceleration sensor 6 and a monitoring unit 8. The rail vehicle 2 also has a speedometer 10 for determining a speed of the rail vehicle 2. The speedometer 10 comprises a rotational speed sensor and determines the speed of the rail vehicle 2 on the basis of a rotational speed. The acceleration sensor 6 and the speedometer 10 of the rail vehicle 2 are disposed on a wheelset axle 12 of the rail vehicle 2.

The monitoring unit 8 comprises a high-pass filter 14, a bandpass filter 16, a monitoring counter 18, a first time counter 20, and a second time counter 22. The first time counter 20 counts a first time and the second time counter 22 counts a second time. The monitoring counter 18 and the time counter 20, 22 can be a separate device in each case or be implemented as a software function in the monitoring unit 8.

The acceleration sensor 6 is a sensor for measuring a lateral acceleration of the rail vehicle 2. When the acceleration sensor 6 is working properly, the acceleration sensor 6 therefore measures the lateral acceleration of the rail vehicle 2. That is to say, the acceleration sensor 6 produces a signal in the form of a voltage which is dependent on the lateral acceleration of the rail vehicle 2. A lateral acceleration calculated from the signal consequently corresponds to the true lateral acceleration if the acceleration sensor is defect-free, i.e. working properly. On the other hand, if the acceleration sensor 6 is defective, the lateral acceleration calculated from the signal is not necessarily the true lateral acceleration of the rail vehicle 2.

The measurement of the lateral acceleration of the rail vehicle 2 is used to monitor the running stability of the rail vehicle 2.

In addition, the monitoring unit 8 is used to detect a defect in the acceleration sensor 6. The monitoring unit 8 checks whether a variable dependent on the signal of the acceleration sensor 6 fulfills a predefined condition in respect of a reference value, and determines on the basis of the test whether the acceleration sensor 6 is defective. The signal-dependent variable is the lateral acceleration that is determined from the signal. In particular, the test checks whether lateral acceleration values fulfill a predefined condition in respect of a reference value.

In this exemplary embodiment, the bandpass filter 16 is a filter for the frequency range 3 to 9 Hz. In the frequency range 3 to 9 Hz, mechanical vibrations typically occur because of the lateral accelerations of the rail vehicle 2. Consequently, the bandpass filter 16 allows through the frequency range 3 to 9 Hz.

The signal produced by the acceleration sensor 6 is filtered and averaged and the individual signal values are converted into an acceleration value in each case by a unique conversion rule.

Three tests are then carried out in which it is checked in each case whether the lateral acceleration fulfills a predefined condition in respect of a reference value. In the three tests, three different conditions are checked in respect of three different predefined reference values. Two of the conditions are dependent on the speed of the rail vehicle 2. For these two conditions it is assumed that particular lateral accelerations are likely at particular speeds of the rail vehicle 2. If such lateral accelerations are not achieved, an acceleration sensor defect 6 is assumed, i.e. detected. The three tests will now be discussed with reference to FIGS. 2 to 4.

FIG. 2 shows a first graph in which the lateral acceleration a of the rail vehicle 2 determined using the acceleration sensor 6 is plotted as a function of time t. This graph serves to illustrate the first test.

The first test is carried out independently of the speed of the rail vehicle 2. In the first test it is checked whether the lateral acceleration a is greater than a first reference value r₁. The first reference value r₁ is a maximum value of the measurement range of the acceleration sensor 6.

To calculate the lateral acceleration a, the signal of the acceleration sensor 6 is fed to the monitoring unit 8. In the monitoring unit 8 the signal is filtered by means of a bandpass filter 16. The filtered signal is then averaged by the monitoring unit 8 by means of moving averaging of absolute values over a predefined time period. Absolute value averaging means that the absolute value is first formed from each signal value and then arithmetic averaging is performed over a plurality of signal values, all lying within the predefined time period. The predefined time period is e.g. 0.5 s.

The signal values of the filtered, averaged signal are converted into acceleration values by means of a conversion rule.

The first reference value r₁ can be e.g. 10 m/s². In the first test it is checked whether the acceleration values exceed a predefined multiple a₁ of the first reference value r₁. The multiple a₁ of the first reference value r₁ can be e.g. 1.5 times the first reference value r₁. This means that the lateral acceleration a (or rather each acceleration value determined) is compared with the multiple a₁ of the first reference value r₁, e.g. 1.5 times the first reference value r₁.

The graph in FIG. 2 is subdivided into two time intervals A, B, the first time interval A preceding the second time interval B. In the first time interval A, the acceleration values are below the multiple a₁ of the first reference value r₁. The acceleration sensor 6 is deemed operational in the first time interval A according to this first test. After the time interval A, the lateral acceleration a increases significantly, e.g. because of a wiring fault in the acceleration sensor 6 or because a spurious signal is injected. In the second time interval B, the acceleration values exceed the multiple a₁ of the first reference value r₁, so that an acceleration sensor defect 6 is detected and a warning is issued.

In addition, the bandpass filter 16 is checked for operability by means of the first test. For example, there may be a defect in the bandpass filter 16 if the variable exceeds the predefined multiple a₁ of the first reference value r₁.

Due the warning issued, the bandpass filter 16 and the acceleration sensor 6 can be checked, and repair or replacement of the defective element carried out if necessary.

FIG. 3 shows a second graph in which the lateral acceleration a of the rail vehicle 2 determined using the acceleration sensor 6 is plotted as a function of time t. This graph serves to illustrate the second test.

The second test is carried out if the speed of the rail vehicle 2 falls below the predefined lower speed limit, e.g. 0.5 km/h. The second test is also carried out in respect of a second reference values r₂.

It is assumed that, in the case of a speed of the rail vehicle 2 below the lower speed limit, only acceleration values below the second reference value r₂ are likely. The reason is that normally only small lateral accelerations a act on the rail vehicle 2 when the vehicle is traveling very slowly or is at a standstill. On the other hand, if acceleration values above the second reference value r₂ are measured, an acceleration sensor defect 6 is assumed, i.e. detected.

To calculate the lateral acceleration a, the signal of the acceleration sensor 6 is passed to the monitoring unit 8. In the monitoring unit 8 the signal of the acceleration sensor 6 is filtered by means of the high-pass filter 14 so that an offset voltage is attenuated in the signal or rather filtered out of the signal. The high pass filtered signal is then averaged by means of moving quadratic averaging over a time period of e.g. 0.5 s.

The signal values of the filtered, averaged signal are then converted into acceleration values by a conversion rule.

In this second test it is checked whether the acceleration value exceeds the second reference value r₂ by the time the first time counted by the first time counter 20 reaches a predefined first time value. The second reference value r₂ can be e.g. 3.0 m/s².

The graph in FIG. 3 is subdivided into three time intervals C, D, E, the first time interval C preceding the second time interval D. The second time interval D in turn precedes the third time interval E.

In the first time interval C, the lateral acceleration a is significantly below the second reference value r₂. The acceleration sensor 6 is deemed operational according to this test in time interval C. After the first time interval C, the lateral acceleration a increases markedly, e.g. because of an electronic fault in or at the acceleration sensor 6, and lies close to the second reference value r₂ in the subsequent time intervals D and E. The lateral acceleration a exceeds the second reference value r₂ in the time intervals D and E at the points indicated by arrows.

The second test is also used to determine how often the lateral acceleration a exceeds the second reference value r₂ by the first time the predefined first time value is reached. The test also checks whether the number of exceedances exceeds the predefined maximum number, e.g. nine. The number of exceedances is counted by the above mentioned exceedance counter 18.

Testing to ascertain whether the number of exceedances exceeds a predefined maximum number is carried out in order to exclude the possibility that a one-off event, such as e.g. a passing train or a one-off mechanical impact on a wheel truck of the rail vehicle 2, causes a warning to be issued on account of a presumed defect in the acceleration sensor 6.

If—unlike in the case described—the number is less than the predefined maximum number and the first time reaches the predefined first time value, the exceedance counter 18 is reset to zero.

In the third time interval E, the number of exceedances has exceeded the predefined maximum number and the first time has reached or exceeded the predefined first time value. In order words, in the case of a predefined maximum number of e.g. nine, the exceedance counter 18 has counted e.g. ten (or more) exceedances before the first time reaches the predefined first time value. An acceleration sensor defect 6 is consequently identified. A warning is issued and the signal of the acceleration sensor 6 is no longer involved in assessing the running stability of the rail vehicle 2.

The first time is decremented by the first time counter 20 from an initial value (e.g. 30 min), said first time counter 20 being reset to the initial value when the first time reaches the predefined first time value of zero. The first time counter 20 is stopped if the speed of the rail vehicle 2 is equal to or above the predefined lower speed limit. If the speed of the rail vehicle 2 falls below the predefined lower speed limit again, the time counter 20 resumes counting.

FIG. 4 shows a fourth graph in which the lateral acceleration a and the speed v of the rail vehicle 2 are plotted as a function of time t. The lateral acceleration a has been determined using the acceleration sensor 6. The speed v has also been determined using the speedometer 10. The lateral acceleration a is shown as a continuous line and the y-axis for the lateral acceleration a is on the left-hand side of the drawing. In addition, the speed v is shown as a dashed line and the y-axis for the speed v is on the right-hand side of the drawing. This third graph serves to illustrate the third test.

The third test is carried out if the speed v of the rail vehicle 2 exceeds a predefined upper speed limit vₒ, e.g. 160 km/h. In addition, the third test is carried out in respect of a third reference value r₃.

For this test it is assumed that, at a speed v of the rail vehicle 2 above the upper speed limit vₒ, at least some of the acceleration values are likely to be above the third reference value r₃. The reason is that normally higher lateral accelerations a act on the rail vehicle 2 when the vehicle is traveling at high speed. On the other hand, if the acceleration values never exceed the third reference value r₃, an acceleration sensor defect 6 is assumed, i.e. detected.

To calculate the lateral acceleration a, the signal of the acceleration sensor 6 is passed to the monitoring unit 8. In the monitoring unit 8 the signal is filtered by means of a high-pass filter 16. The filtered signal is then averaged by the monitoring unit 8 by means of moving quadratic averaging over a time period of e.g. 0.5 s.

The signal values of the filtered, averaged signal are then converted into acceleration values by a conversion rule.

In the third test it is checked whether the lateral acceleration a ever exceeds the third reference value r₃ by the time the second time reaches a predefined second time value of e.g. 2 h. The third reference value r₃ can be e.g. 0.3 m/s².

The second time is incremented starting from zero by the second time counter 22.

The graph in FIG. 4 is subdivided into five time intervals F, G, H, J, K, the first time interval F preceding the second time interval G. The second time interval G in turn precedes the third time interval H which precedes the penultimate time interval J. The penultimate time interval J precedes the last time interval K. In the first time interval F, the acceleration values are continuously above the third reference value r₃, whereas the lateral acceleration a decreases significantly after the time interval F, e.g. because of cable breakage inside the acceleration sensor 6, and the lateral acceleration a is continuously below the third reference value r₃ after the time interval F.

In the first time interval F, the speed v of the rail vehicle 2 exceeds the predefined upper speed limit vₒ. As already mentioned, in this time interval F the lateral acceleration a is constantly above the third reference value r₃. The acceleration sensor 6 is deemed to be fully operational in the time interval F. In this case, the second time counter 22 increments the time starting from zero, but the second time counter 22 is reset to the initial zero value each time the third reference value r₃ is exceeded.

In the second time interval G, the speed v of the rail vehicle 2 exceeds the predefined upper speed limit vₒ, so that the time is counted by means of the second time counter 22. However, the lateral acceleration a after the time interval F is constantly below the third reference value r₃ in this time interval G, with the result that the second time counter 22 is not reset, i.e. the time continues to be counted by the second time counter 22.

In the third time interval H, the speed v of the rail vehicle 2 is less than or equal to the predefined upper speed limit vₒ, with the result that the second time counter 22 is stopped, i.e. the time does not continue to be counted.

In FIG. 4, the time axis has a break between the third time interval H and the penultimate time interval J, and additional time intervals can follow the third time interval H.

In the penultimate time interval J, the speed v of the rail vehicle 2 exceeds the predefined upper speed limit vₒ, with the result that the time continues to be counted by means of the second time counter 22. The lateral acceleration a after the time interval F is continuously below the third reference value r₃ in this time interval J, which means that the second time counter 22 is not reset. At the end of the time interval J, the second time counter 22 reaches the predefined second time value.

In the last time interval K, the second time counter 22 has reached or exceeded the second time value. The lateral acceleration a has therefore never exceeded the predefined third reference value r₃ by the time the predefined second time value has been reached. Consequently, an acceleration sensor defect 6 is identified in the last time interval. A warning is issued and the signal of the acceleration sensor 6 is no longer involved in evaluating the running stability of the rail vehicle 2.

The rail vehicle 2 can in principle have yet more acceleration sensors which can monitor for a defect in a manner similar to that described in the exemplary embodiment.

Although the invention has been illustrated and described in detail on the basis of the preferred exemplary embodiment, the invention is not limited to the example disclosed and other variations will be apparent to persons skilled in the art without departing from the scope of protection sought for the invention.

1-15. (canceled)

16. A method for detecting a defect in an acceleration sensor, which comprises the steps of:
generating, via the acceleration sensor, a signal;
carrying out a test to check whether a variable dependent on the signal fulfills a predefined condition in respect of a reference value; and
determining on a basis of the test whether the acceleration sensor is defective.

17. The method according to claim 16, wherein the variable is an acceleration determined on a basis of the signal.

18. The method according to claim 16, wherein the variable is a variable calculated by averaging a plurality of consecutive signal values.

19. The method according to claim 16, which further comprises filtering the signal of the acceleration sensor using a filter and the test is carried out for a filtered signal.

20. The method according to claim 16, wherein the reference value is a maximum value of a measurement range of the acceleration sensor and the test checks whether the variable exceeds a predefined multiple of the reference value.

21. The method according to claim 16, which further comprises disposing the acceleration sensor in a movable object and the reference value is dependent on a speed of the movable object, wherein the speed of the movable object is measured by means of a speedometer.

22. The method according to claim 21, which further comprises counting time via a time counter and, if the speed of the movable object is below a predefined lower speed limit, the test checks whether the variable exceeds the reference value by the time a predefined time value is reached.

23. The method according to claim 21, which further comprises counting time via a time counter and, if the speed of the movable object is below a predefined lower speed limit, the test determines how often the variable exceeds the reference value by the time a predefined time value is reached and whether a number of exceedances exceeds a predefined maximum number, wherein the number of exceedances is determined by an exceedance counter and the exceedance counter is reset if the number of exceedances is less than the predefined maximum number and the time reaches the predefined time value.

24. The method according to claim 21, which further comprises counting time via a time counter and, if the speed of the movable object exceeds a predefined upper speed limit, the test checks whether the variable ever exceeds the predefined reference value by the time a predefined time value is reached.

25. The method according to claim 24, which further comprises resetting the time counter each time the reference value is exceeded and the time only continues to be counted by the time counter if the speed of the movable object exceeds the predefined upper speed limit.

26. The method according to claim 21, wherein the acceleration sensor is a sensor for measuring an acceleration at right angles to a direction of travel of the movable object.

27. The method according to claim 16, which further comprises issuing a warning if the acceleration sensor defect is detected.

28. The method according to claim 16, which further comprises disposing the acceleration sensor in a rail vehicle and the acceleration sensor is used for monitoring running stability.

29. The method according to claim 19, which further comprises selecting the filter from the group consisting of a bandpass filter and a high-pass filter.

30. The method according to claim 21, wherein the movable object is a vehicle.

31. A measuring system, comprising:
an acceleration sensor; and
a monitoring unit configured to detect a defect in said acceleration sensor, said monitoring unit programmed to:
receive, via said acceleration sensor, an acceleration signal;
carry out a test to check whether a variable dependent on the acceleration signal fulfills a predefined condition in respect of a reference value; and
determine on a basis of the test whether said acceleration sensor is defective.

32. A rail vehicle, comprising:
a measuring system having an acceleration sensor and a monitoring unit configured to detect a defect in said acceleration sensor, said monitoring unit programmed to:
receive, via said acceleration sensor, an acceleration signal;
carry out a test to check whether a variable dependent on the acceleration signal fulfills a predefined condition in respect of a reference value; and
determine on a basis of the test whether said acceleration sensor is defective.
